(19) United States
(12) Patent Application Publication
(10) Pub. No.: US 2024/0379998 A1
(43) Pub. Date: Nov. 14, 2024

(54) SOLID ELECTROLYTE MATERIAL AND METHOD OF FORMING SAME

(71) Applicant: SAINT-GOBAIN CERAMICS & PLASTICS, INC., Worcester, MA (US)

(72) Inventor: Alireza SHIRAZI-AMIN, Berlin, MA (US)

(21) Appl. No.: 18/658,639

(22) Filed: May 8, 2024

Related U.S. Application Data
(60) Provisional application No. 63/500,982, filed on May 9, 2023.

(51) Int. Cl. H01M 10/0562

(52) U.S. Cl. CPC H01M 10/0562; H01M 2300/008; H01M 2300/0094

(57) ABSTRACT

A solid electrolyte material may include a first solid electrolyte material overlying at least a portion of a second solid electrolyte material. The first solid electrolyte material may include MₐMe_{f}O_{b}X_{c}, wherein M comprises an alkali metal, X comprises a halogen, 0≤f≤1, (a/b)>3, c=a+(k×f)−2b, k is a valence of Me, and Me comprises a metal different from M. The second solid electrolyte material may include a halide.

### CROSS-REFERENCE TO RELATED APPLICATION(S)

This application claims priority under 35 U.S.C. § 119 (c) to U.S. Provisional Application No. 63/500,982, entitled “SOLID ELECTROLYTE MATERIAL AND METHOD OF FORMING SAME,” by Alireza SHIRAZI-AMIN, filed May 9, 2023, which is assigned to the current assignee hereof and incorporated herein by reference in its entirety.

### FIELD OF THE DISCLOSURE

The following is directed to a solid electrolyte material and methods for forming the same.

### DESCRIPTION OF THE RELATED ART

Solid state lithium batteries are expected to provide higher energy densities and faster recharging times and cause less safety concerns compared to conventional lithium ion batteries, by enabling lithium metal anode. Uses of solid state electrolytes have been demonstrated to help improve performance of lithium metal anodes. Limited wettability of solid electrolyte by lithium metal can cause increased interfacial resistance. Low stability of solid electrolyte interfacing lithium metal anode can cause uneven lithium plating and/or stripping during battery cycling, which can result in formation of lithium dendrites, dead lithium, and mechanical stress on both the solid electrolyte and lithium metal anode. The industry continues to demand solid state batteries with improved performance.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a cross section of a solid electrolyte material in accordance with an embodiment herein.

FIG. 2A includes an illustration of a solid electrolyte material in form of particles according to another embodiment.

FIG. 2B includes an illustration of a cross section of a layer including the solid electrolyte material of FIG. 2a in accordance with an embodiment herein.

FIG. 2C includes an illustration of a cross section of a portion of a structure including the layer of FIG. 2C in accordance with an embodiment herein.

FIG. 3 includes a cross-sectional illustration of a portion of a multi-layer structure in accordance with an embodiment herein.

FIG. 4 includes an illustration of a process in accordance with an embodiment herein.

FIG. 5 includes illustrations X-ray diffraction analysis of solid electrolyte materials.

FIG. 6 includes an illustration of an XPS analysis of a representative solid electrolyte material.

FIG. 7 includes a plot of voltage vs. specific capacity of solid electrolyte materials of embodiments herein.

FIG. 8 includes a graph including electrochemical impedance spectroscopy results of solid electrolyte materials.

FIG. 9 includes a plot of voltage vs. specific capacity of a solid electrolyte material.

FIG. 10 includes a graph including cyclic voltammogram analysis of solid electrolyte materials.

FIG. 11 includes a plot of voltage vs. specific capacity of solid electrolyte materials.

FIG. 12 includes a plot of voltage vs. specific capacity of different solid electrolyte materials.

Skilled artisans appreciate that elements in the figures are illustrated for simplicity and clarity and have not necessarily been drawn to scale. For example, the dimensions of some of the elements in the figures can be exaggerated relative to other elements to help improve understanding of embodiments of the invention. The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having”, or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting.

Embodiments herein relate to a solid electrolyte material including a first solid electrolyte material including an oxyhalide material overlying at least a portion of a second solid electrolyte material including a halide different from the oxyhalide material. In an embodiment, the halide of the second solid electrolyte material may include at least two cations. The solid electrolyte material may have different forms. In a particular embodiment, the solid electrolyte material may include a layered structure, wherein the first solid electrolyte material and the second electrolyte material may independently be in the form of a sheet, a tape, a block, a film, or the like. In another particular embodiment, the solid electrolyte material may be in the form of particles. For example, the solid electrolyte material may include coated particles including a coating including the first solid electrolyte material and a core including the second electrolyte material. The solid electrolyte material may have improved ionic conductivity, ion diffusion rate, capacity retention, or any combination thereof. The solid electrolyte material may also facilitate improved stability of the solid electrolyte material and improved performance of a solid-state battery. Certain embodiments herein may relate to the first solid electrolyte material.

Further embodiments relate to methods of forming the solid electrolyte material. The methods can allow for the improved formation of the solid electrolyte material and facilitate the formation of the solid electrolyte material having improved properties. Certain embodiments may relate to formation of the first solid electrolyte material.

In an embodiment, the solid electrolyte material may include the first solid electrolyte material including an oxyhalide material. In a further embodiment, the oxyhalide material may be represented by Mₐ(Me)_{f}O_{b}X_{c}, wherein M may include alkali metal, Me may include metal different than M, X may include a halogen, 0≤f≤1, (a/b)>3, c=a+(k×f)−2b, k is a valence of Me, and 2≤k≤6. In at least one particular embodiment, M may include Li and optionally, another alkali metal including Na, K, Cs, Rb, or any combination thereof. For example, M may include Li and at least one of Na, K, and Cs. In another particular embodiment, M may include Li, Na, or both. For example, M may consist of Li, Na, or both. In a particular example, the oxyhalide may be represented by Liₐ(Me)_{f}O_{b}X_{c}. In another example, M may include Li, wherein Li may make up at least 50 mol %, or at least 60 mol %, or at least 66 mol %, or at least 75 mol % of M. In a particular example, M can include from 60 mol % to 100 mol % Li. In a further example, M may include at least 10 mol % of Na, or at least 20 mol %, or at least 40 mol % of Na. In another example, M may include at most 40 mol % of Na, or at most 34 mol %, or at most 30 mol %, or at most 20 mol %, or at most 10 mol % of Na. In another example, M may be essentially free of Na. In a further example, M may include from 0 mol % to 100 mol % of Na or an amount of Na in a range including any of the minimum and maximum percentages noted herein, such as in a range from 40 mol % to 100 mol % of M.

In a further embodiment, Me may include a divalent metal element, a trivalent metal element, a tetravalent metal element, a pentavalent metal element, a hexavalent metal element, or any combination thereof. A particular example of Me may include a rare earth element, a transition metal, Y, Zr, or any combination thereof. An example of the rare earth element can include Sc, La, Ce, Pr, Nd, Sm, Gd, Dy, Tm, Yb, Eu, Tb, or any combination thereof. An exemplary transition metal can include Sc, Ti, V, Cr, Mn, Fe, In, Co, Ni, Cu, Zn, Y, Zr, Nb, Mo, Pd, Ag, Hf, Cd, W, Pt, Au, or any combination thereof. In a particular example, f=0.

In a further embodiment, X may include Br, Cl, F, or any combination thereof. For example, X may include Br. In another example, X may include Cl. In a further example, X may include Br and at least one of Cl, I, and F. In a particular embodiment, X may consist of a halogen. For example, X may consist of Br; or alternatively X may consist of Br and one or more of Cl, F, and I. In another example, X may consist of Br; or alternatively X may consist of Br and one or more of Cl and F. In a further example, X may consist of Br and Cl. In a further example, X may consist of Br and F. In still another example, X may consist of Br.

In an embodiment, a>3. For example, a may be at least 4, at least 5, at least 6, or at least 7. In another example, a may be at most 9, at most 8, or at most 7. Moreover, a may be in the range including any of the minimum and maximum values noted herein.

In another embodiment, b>1. For example, b may be at least 2, or at least 3. In another example, b may be at most 3, at most 2, or at most 1. Moreover, b may be in range including any of the minimum and maximum values noted herein.

In another embodiment, c may be greater than 1. For example, c may be at least 2 or at least 3. In another example, c may be at most 5, or at most 4, or at most 3. Moreover, c may be in a range including any of the minimum and maximum values noted herein.

In a further embodiment, the ratio of a to b (a/b) may be at most 4. For example, a/b may be at most 3.8, or at most 3.7, or at most 3.6, or at most 3.5. In a further example, a/b may be greater than 3, such as at least 3.1, at least 3.3, or at least 3.5. Moreover, a/b may be in a range including any of the minimum and maximum values noted herein.

In a particular embodiment, the first solid electrolyte material can include Li₇O₂X₃, wherein X may include Br, Cl, F, or any combination thereof. In another example, the first solid electrolyte may include Li₇O₂X₃ doped with Y, Zr, Gd, Sc, Ce, Er, La, Yb, In, Mg, Zn, or any combination thereof.

In another embodiment, the metal oxyhalide may include Li₇O₂(Br_{d}FₑCl_{(1-d-e)})₃, wherein 0≤(d+e)≤1. In an example, (d+e)>0. In a further example, d>0 and e>0. In a further example, d>e. In a further example, d>e>0. In another example, 0<(d+c)<1. In a further example, (d+c)=0.

In another embodiment, the metal oxyhalide may include Li₇O₂(Br_{d}F_{1-d})₃, wherein 0≤d≤1. In a particular example, d may be greater than 0, such as at least 0.1, at least 0.3, at least 0.5, or at least 0.7. Additionally or alternatively, d may be at most 1, such as at most 0.9, at most 0.8, at most 0.6, or at most 0.4. Moreover, d may be in a range including any of the minimum and maximum values noted herein, such as in a range of greater than 0 and at most 1. In at least one particular instance, d=1. In another example, d=0.

In a particular embodiment, the metal oxyhalide may include Li₇O₂(Br_{d}Cl_{(1-d)})₃, wherein 0≤d≤1. In a particular example, d may be greater than 0, such as at least 0.1, at least 0.3, at least 0.5, or at least 0.7. Additionally or alternatively, d may be at most 1, such as at most 0.9, at most 0.8, at most 0.6, or at most 0.4. Moreover, d may be in a range including any of the minimum and maximum values noted herein, such as in a range of greater than 0 and at most 1. In at least one particular instance, d=1. In another example, d=0.

In a further embodiment, the first solid electrolyte material may include a metal hydroxide halide. The metal hydroxide halide may be represented by M′ₘ(Me′)_{f′}(OH)ₙX′ₚ, wherein M′ may include an alkali metal, X′ may include a halogen, 1≤m≤5, 0×f′≤1, 1≤n≤4, p=m+ (k′×f′)−n, k′ is a valence of Me′, and Me′ may include a metal different from M′. For example, Me′ may include a divalent metal element, a trivalent metal element, a tetravalent metal element, a pentavalent metal element, a hexavalent metal element, or any combination thereof. A particular example of Me′ may include a rare earth element, a transition metal, Y, Zr, or any combination thereof. An example of the rare earth element can include Sc, La, Ce, Pr, Nd, Sm, Gd, Dy, Tm, Yb, Eu, Tb, or any combination thereof. An exemplary transition metal can include Sc, Ti, V, Cr, Mn, Fe, Co, Ni, Cu, Zn, Y, Zr, Nb, Mo, Pd, Ag, Hf, Cd, W, Pt, Au, or any combination thereof.

In an embodiment, M′ may include alkali metal including Li, Na, K, Cs, Rb, or any combination thereof. In a further embodiment, M′ may include Li, Na, or both. In a particular embodiment, M′ may include Li and optionally one or more of Na, K, Cs, and Rb. For example, M′ may include Li and Na. In another example, M′ may consist essentially of Li.

In a further embodiment, X′ may include Br, Cl, F, or any combination thereof. For example, X′ may include Br. In another example, X′ may include Cl. In a further example, X′ may include Br and at least one of Cl, I, and F. In a particular embodiment, X′ may consist of a halogen. For example, X′ may consist of Br and optionally one or more of Cl, F, and I. In another example, X′ may consist of Br and optionally, one or more of Cl and F. In a further example, X′ may consist of Br and Cl. In a further example, X′ may consist of Br and F. In still another example, X′ may consist of Br.

In a further embodiment, the metal hydroxide halide may be represented by Liₘ(OH)ₙX′ₘ₋ₙ wherein 2≤m≤5, and 1≤n≤4. In at least one example, Liₘ(OH)ₙX′ₘ₋ₙ may be doped with Y, Zr, Gd, Sc, Ce, Er, La, Yb, In, Mg, Zn, or any combination thereof.

In another embodiment, the metal hydroxide halide may include Li₂(OH)X′.

In a further embodiment, the metal hydroxide halide may include Li₂(OH)Br_{d′}F_{e′}Cl_{(1-d′-e′)}, wherein 0≤(d′+c′)≤1. In an example, 0<(d′+c′)≤1. In a further example, d>0 and c>0. In a further example, d′>e′>0. In another example, 0<(d′+c′)<1.

In a particular embodiment, the metal hydroxide halide may include Li₂(OH)Br_{d′}F_{(1-d′)}, wherein 0≤d′≤1. In a more particular example, d′ may be greater than 0, such as at least 0.1, at least 0.3, at least 0.5, at least 0.7, or at least 0.9. Additionally or alternatively, d′ may be at most 1, such as at most 0.9, at most 0.8, at most 0.7, or at most 0.5. Moreover, d′ may be in a range including any of the minimum and maximum values noted herein, such as in a range of greater than 0 and at most 1. In at least one particular example, d′=1. In another example, d′=0.

In a particular embodiment, the metal hydroxide halide may include Li₂(OH) Br_{d′}Cl_{(1-d′)}, wherein 0≤d′≤1. In a more particular example, d′ may be greater than 0, such as at least 0.1, at least 0.3, at least 0.5, or at least 0.7. Additionally or alternatively, d′ may be at most 1, such as at most 0.9, at most 0.8, at most 0.6, or at most 0.4. Moreover, d′ may be in a range including any of the minimum and maximum values noted herein, such as in a range of greater than 0 and at most 1. In at least one particular example, d′=1. In another example, d′=0.

In another embodiment, the metal hydroxide halide may include Li₄(OH)₃X′.

In an embodiment, the first solid electrolyte material may include a particular weight content ratio between the metal oxyhalide and the metal hydroxide halide that may facilitate improved performance of the solid electrolyte material. In an example, the ratio, C_{MOX}/C_{M′OHX′}, may be at least 0.05, at least 0.07, at least 0.10, at least 0.13, at least 0.15, at least 0.18, at least 0.20, at least 0.23, at least 0.25, at least 0.28, at least 0.30, at least 0.32, at least 0.34, at least 0.36, at least 0.38, or at least 0.40, wherein C_{MOX} may be a weight content of the metal oxyhalide for a total weight of the first solid electrolyte material, and C_{M′OHX′} may be a weight content of the metal hydroxide halide for the total weight of the first solid electrolyte material. In a further example, the weight content ratio, C_{MOX}/C_{M′OHX′}, may be not greater than 100, not greater than 50, not greater than 20, not greater than 10, not greater than 6, not greater than 3, not greater than 2, not greater than 1, not greater than 0.90, not greater than 0.80, not greater than 0.70, not greater than 0.60, not greater than 0.50, or not greater than 0.40. Moreover, the weight ratio C_{MOX}/C_{M′OHX′} may be in a range including any of the minimum and maximum values noted herein.

In an embodiment, the first solid electrolyte material may include a particular content of the metal oxyhalide material that may facilitate improved performance of the solid electrolyte material. In an example, the content of the metal oxyhalide material may be at least 1 wt % for the total weight of the first electrolyte material, such as at least 3 wt %, at least 5 wt %, at least 8 wt %, at least 10 wt %, at least 14 wt %, at least 18 wt %, at least 22 wt %, at least 26 wt %, at least 28 wt %, at least 30 wt %, at least 34 wt %, at least 38 wt %, at least 43 wt %, at least 48 wt %, at least 50 wt %, at least 54 wt %, or at least 56 wt % for the total weight of the first electrolyte material. In another example, the content of the metal oxyhalide material may be at most 56 wt % for the total weight of the first electrolyte material, such as at most 53 wt %, at most 51 wt %, at most 49 wt %, at most 46 wt %, at most 43 wt %, at most 40 wt %, at most 37 wt %, at most 34 wt %, at most 31 wt %, at most 28 wt %, at most 24 wt %, at most 21 wt %, at most 18 wt %, at most 15 wt %, at most 12 wt %, at most 9 wt %, or at most 5 wt % for the total weight of the first electrolyte material. Moreover, the content of the metal oxyhalide material may be in a range including any of the minimum and maximum percentages noted herein.

In an embodiment, the first solid electrolyte material may include a particular content of the metal hydroxyl halide material that may facilitate improved performance of the solid electrolyte material. In an example, the content of the metal hydroxyl halide material may be greater than 53 wt % for the total weight of the first electrolyte material, such as at least 55 wt %, at least 58 wt %, at least 62 wt %, at least 65 wt %, at least 68 wt %, at least 70 wt % or at least 72 wt % for the total weight of the first electrolyte material. In another example, the content of the metal hydroxyl halide material may be at most 99 wt % for the total weight of the first electrolyte material, such as at most 95 wt %, at most 91 wt %, at most 89 wt %, at most 86 wt %, at most 83 wt %, at most 80 wt %, at most 78 wt %, at most 75 wt %, at most 73 wt %, or at most 72 wt % for the total weight of the first electrolyte material. Moreover, the content of the metal hydroxyl halide material may be in a range including any of the minimum and maximum percentages noted herein.

In an embodiment, the first solid electrolyte material may include a certain content of a binary metal halide other than binary metal fluoride, such as LiBr, LiI, and/or LiCl, that may facilitate improved performance of the solid electrolyte material. In a particular example, the first electrolyte material may be essentially free of a binary metal iodide. In a further embodiment, the first solid electrolyte material may include a certain content of binary alkali bromide that may facilitate improved performance of the solid electrolyte material. In an example, the content of a binary alkali bromide may be less than 4 wt %, such as at most 3 wt %, at most 2 wt %, at most 1 wt %, or at most 0.5 wt % for the total weight of the first electrolyte material. In a particular example, the first electrolyte material may be essentially free of a binary metal bromide, such as binary alkali bromide. In still another example, the first electrolyte material may include at least 0.001 wt % of binary alkali bromide, such as at least 0.01 wt %, at least 0.05 wt %, at least 0.1 wt % or at least 0.2 wt % for the total weight of the first electrolyte material. Moreover, the content of the binary alkali bromide may be in a range including any of the minimum and maximum percentages noted herein. In a further embodiment, the first electrolyte material may include binary alkali chloride in any of the contents described with respect to binary alkali bromide herein.

In an embodiment, the first solid electrolyte material may include a particular weight content ratio between the metal oxyhalide and binary alkali bromide that may facilitate improved performance of the solid electrolyte material. In an example, the ratio, C_{MOX}/C_{ABr}, may be at least 10.9 or greater, such as at least 13 or higher, wherein Cox may be a weight content of the metal oxyhalide for a total weight of the first solid electrolyte material, and C_{ABr} may be a weight content of the binary alkali bromide for the total weight of the first solid electrolyte material. In a further embodiment, the first solid electrolyte material may include a particular weight content ratio between the metal hydroxyl halide and binary alkali bromide that may facilitate improved performance of the solid electrolyte material. In an example, the ratio, C_{M′OHX′}/C_{ABr}, may be at least 13.5, such as at least 15, or greater, wherein C_{M′OHX′} may be a weight content of the metal hydroxyl halide for a total weight of the first solid electrolyte material, and C_{ABr} may be a weight content of the binary alkali bromide for the total weight of the first solid electrolyte material. It is to be appreciated a weight content ratio of the metal hydroxyl halide to the binary alkali chloride can include any ratios noted with respect to C_{M′OHX′}/C_{ABr}. It is to be further appreciated a weight content ratio of the metal oxyhalide to the binary alkali chloride can include any ratios noted with respect to C_{MOX}/C_{ABr}.

In a further embodiment, the first solid electrolyte material may include a plurality of crystalline phase including a first phase that may include the metal oxyhalide and the second phase that may include the metal hydroxide halide. In an aspect, the first phase may include a crystalline phase including MₐMe_{f}O_{b}X_{c} and a second crystalline phase including M′ₘ(Me′)_{f′}(OH)ₙX′ₚ, wherein each of X and X′ may include Cl, Br, or both. In an embodiment, the first solid electrolyte material may include a content of the first crystalline phase, wherein the content of the first crystalline phase may include any of the contents described with respect of the content of the metal oxyhalide. In another embodiment, the first solid electrolyte material may include a content of the second crystalline phase, wherein the content of the second crystalline phase may include any of the contents described with respect of the content of the metal hydroxyl halide. In a particular example, the first solid electrolyte material may include a first crystalline phase including Li₇O₂X₃ and a second crystalline phase including lithium hydroxide halide. In another particular example, the first crystalline phase may include Li₇O₂X₃ and the second crystalline may include Li₂OHX′. In still another example, the first crystalline phase may include Li₇O₂X₃ and the second crystalline may include Li₄(OH)₃X′. In another aspect, the first solid electrolyte material may include a third phase. In an example, the third phase may include a crystalline phase. In another example, the first solid electrolyte material may include a first crystalline phase including Li₇O₂X₃, a second crystalline phase including Li₂OHX′, and a third crystalline phase including Li₄(OH)₃X′. In at least one embodiment, the first solid electrolyte material may include a crystalline phase including binary alkali metal halide other than fluoride, such as LiBr. In an embodiment, the first solid electrolyte material may include a content of the crystalline phase including binary alkali metal halide other than fluoride, wherein such content may include any of the contents described with respect of the content of the binary alkali bromide. In another embodiment, the first solid electrolyte material may include a plurality phases including crystalline phase, amorphous phase, or any combination thereof.

In an embodiment, the first solid electrolyte material may include a dopant including fluorine. For example, fluorine may be present in one or more interstitial sites, vacancies, and/or between layers of a crystalline structure of the metal oxyhalide, metal hydroxide halide, or both. In another embodiment, the first solid electrolyte material may include fluorine-doped metal oxyhalide, fluorine-doped metal hydroxide halide, or both. For example, the first solid electrolyte may include fluorine-doped Li₇O₂Br₃, fluorine-doped Li₂OHBr, fluorine-doped Li₇O₂Cl₃, fluorine-doped Li₂OHCl, or any combination thereof. In a particular example, the first solid electrolyte may include fluorine-doped Li₇O₂Br₃, fluorine-doped Li₂OHBr, or both. In another particular example, the first solid electrolyte may include fluorine-doped Li₇O₂Br₃. In an embodiment, the first electrolyte material may be essentially free of a crystalline phase including an alkali fluoride. For example, the first electrolyte material may be essentially free of a crystalline phase including LiF. In a further example, the first electrolyte material may include fluorine species including a metal-fluorine bond, oxyfluoride species, or any combination thereof.

In a particular embodiment, the first solid electrolyte material may consist essentially of the metal oxyhalide and metal hydroxide halide. For example, the first solid electrolyte material may consist essentially of MₐMe_{f}O_{b}X_{c} and M′ₘ(Me′)_{f}(OH)ₙX′ₚ. In a further example, the metal oxyhalide and metal hydroxide halide may include a same alkali metal, such as Li, Na, or both. In a more particular example, the first solid electrolyte material may consist essentially of Li₇O₂X₃ and Li₂OHX′. In another particular example, the first solid electrolyte material may consist essentially of Li₇O₂Br₃ and Li₂OHBr, wherein Li₇O₂Br₃ and/or Li₂OHBr may be doped with fluorine.

In an embodiment, the first solid electrolyte material may include a polycrystal including A_{q} and B_{(1-q)}. In a further embodiment, A may be present in a first crystalline phase including the metal oxyhalide and B may be present in a second crystalline phase including the metal hydroxide halide in a polycrystal. In a particular embodiment, the polycrystal may be constituted of (MₐMe_{f}O_{b}X_{c})_{q} in a first crystalline phase and (M′ₘ(Me′)_{f′}(OH)ₙX′ₚ)_{(1-q)} in a second crystalline phase, wherein M and M′ may independently include Li, Na, or a combination thereof. In an example, X and X′ may independently include at least one of Cl or Br. In a particular example, A may include Li₇O₂X₃ and B may include Li₂OHX′. In a more particular example, X and X′ may independently or both include Br. In an even more particular example, A may include or be represented by Li₇O₂Br₃, and B may include or be represented by Li₂OHBr, wherein Li₇O₂Br₃ and/or Li₂OHBr may be doped with fluorine.

In a further embodiment, the polycrystal may include a particular t that may facilitate improved performance of the solid electrolyte material. In an example, q may be at least 0.05, at least 0.07, at least 0.10, at least 0.13, at least 0.15, at least 0.18, at least 0.20, at least 0.23, at least 0.25, at least 0.28, at least 0.30, at least 0.32, at least 0.34, at least 0.36, at least 0.38, or at least 0.40. In a further example, wherein q may be not greater than 0.95, not greater than 0.90, not greater than 0.85, not greater than 0.80, not greater than 0.75, not greater than 0.70, not greater than 0.65, not greater than 0.60, not greater than 0.55, not greater than 0.50, not greater than 0.45, not greater than 0.40, not greater than 0.35, not greater than 0.30, or not greater than 0.28. Moreover, q may be in a range including any of the minimum and maximum values noted herein.

In an embodiment, the first solid electrolyte material may include improved ionic conductivity comparing to a corresponding solid electrolyte material that has a single phase of the same metal oxyhalide or metal hydroxide halide. For example, the first solid electrolyte material may have a bulk ionic conductivity greater than 6.2×10⁻⁴ mS/cm, such as at least 6.5×10⁻⁴ mS/cm, at least 6.8×10⁻⁴ mS/cm, at least 7.0×10⁻⁴ mS/cm, at least 7.2×10⁻⁴ mS/cm, at least 7.5×10⁻⁴ mS/cm, at least 7.8×10⁻⁴ mS/cm, at least 8.0×10⁻⁴ mS/cm, at least 8.2× 10⁻⁴ mS/cm, at least 8.4×10⁻⁴ mS/cm, at least 8.7×10⁻⁴ mS/cm, at least 9.0×10⁻⁴ mS/cm, or at least 9.3×10⁻⁴ mS/cm. In another example, the may be not greater than 11.2×10⁻⁴ mS/cm, not greater than 10.8×10⁻⁴ mS/cm, not greater than 10.6×10⁻⁴ mS/cm, not greater than 10.4×10⁻⁴ mS/cm, not greater than 10.2×10⁻⁴ mS/cm, not greater than 10.0×10⁻⁴ mS/cm, not greater than 9.8×10⁻⁴ mS/cm, not greater than 9.6×10⁻⁴ mS/cm, or not greater than 9.4×10⁻⁴ mS/cm. Moreover, the first solid electrolyte material may have a bulk ionic conductivity in a range including any of the minimum and maximum values noted herein. As described herein, bulk ionic conductivity is measured at room temperature (i.e., 20° C. to 25° C.).

In an embodiment, the solid electrolyte material may include a second solid electrolyte material including a halide material. In a further embodiment, the second solid electrolyte material may include M″_{3-z}(Me″)_{f}X″_{3-z+k″*f″}, wherein −3≤z<3, k″ is a valence of Me″, 2≤k″<6, 0≤f′≤1, M″ may include an alkali metal element, Me″ may include a metal element different from M″, and X″ may include a halogen. In a further embodiment, the second solid electrolyte material may include (NH₄)_{n″}M″_{3-z}(Me″)_{f″}X″_{n″+3-z″+k″*f″}, wherein 0<n″. In particular examples, f″>0. An exemplary Me″ can include a divalent metal element, a trivalent metal element, a tetravalent metal element, a pentavalent metal element, a hexavalent metal element, or any combination thereof. A particular example of Me″ can include an alkaline earth metal element, 3d transition metal, Zn, Zr, Hf, Ti, Sn, Th, Ge, Ta, Nb, Mo, W, Sb, In, Bi, Al, Ga, or any combination thereof. A more particular example of Me″ can include a rare earth element, Y, Zr, or any combination thereof. Even more particularly, Me″ can include Y, Zr, Gd, Sc, Ce, Er, La, Yb, In, Mg, Zn, or any combination thereof.

An example of M″ may include Li. In a further example, M may include Li and at least one of Na, K, and Cs. In another particular embodiment, M″ may include Li, Na, or both. For example, M″ may consist of Li, Na, or both. In another example, M″ may include Li, wherein Li may make up at least 50 mol %, or at least 60 mol %, or at least 66 mol %, at least 75 mol %, or up to 100 mol % of M″. In a particular example, M″ can include from 60 mol % to 100 mol % Li. In a further example, M″ may include at least 10 mol % of Na, or at least 20 mol %, or at least 40 mol % of Na. In another example, M″ may include at most 40 mol % of Na, or at most 34 mol %, or at most 30 mol %, or at most 20 mol %, or at most 10 mol % of Na. In another example, M″ may be essentially free of Na. In a further example, M″ may include from 0 mol % to 100 mol % of Na or an amount of Na in a range including any of the minimum and maximum percentages noted herein, such as in a range from 40 mol % to 100 mol % of M″.

In an embodiment, X″ may include one or more of F, Cl, Br, and I. In a particular example, X″ may include at least two halogen elements. A more particular example of X″ may include at least two of F, Cl, and Br.

In a particular embodiment, the halide material may be represented by Li_{3-x-f}M″_{f″}RE_{1-y}Me″_{y}(Cl_{1-u-p-q}BrᵤFₚI_{q})_{6-x-y*(k″-3)}, wherein −1≤x≤1; 0≤u<1; 0≤p≤⅓; 0≤q≤⅙; 0<(u+p+q)<1; 0≤f″≤0.3. In a more particular embodiment, the halide material may be represented by Li₃₋ₓRE_{1-y}Me″_{y}(Cl₁₋ᵤBrᵤ)_{6-x+y*(k″-3)}, wherein 0.08≤u≤0.67. M″ may be at least one alkali metal element other than Li. RE may be a rare-earth element. Me″ be at least one element different from RE.

A particular example of the halide material may include Li₃₋ₐNaₐY(BrₓCl_{y})₆, wherein 0≤a≤0.33 and x+y=1. In a more particular example, x≤y. An even more particular example of the solid electrolyte material may include Li₃YBr₆, Li₃YCl₆, Li₃Y(Cl_{0.67}Br_{0.33})₆, Li₃Y(Cl_{0.79}Br_{0.21})₆, Li₃Y(Br_{0.35}Cl_{0.65})₆, Li₃Y(Cl_{0.8}Br_{0.2})₆, Li₃Y(Cl_{0.19}Br_{0.81})₆, Li₃(Y_{0.95}Yb_{0.05})₁(Cl_{0.83}Br_{0.17})₆, Li₃(Y_{0.95}In_{0.05})(Cl_{0.9}Br_{0.1})₆, Li_{2.95}(Y_{0.95}Zr_{0.05})(Cl_{0.9}Br_{0.1})₆, Li₃(Y_{0.85}In_{0.15})Cl₆, (Li_{0.955}Na_{0.045})₃Y₁Cl₆, Li₃Y(Cl_{0.41}Br_{0.59})₆, Li₃Y(Cl_{0.62}Br_{0.38})₆, Li₃YCl₆, LiGdBr₆, LiGdCl₆, Li₃Y(Cl_{0.67}Br_{0.33})₆, Li₃Y(Cl_{0.79}Br_{0.21})₆, or any combination thereof.

In an embodiment, the solid electrolyte material may be essentially free of one or more MX, wherein X may include Br, Cl, I, or any combination thereof. For example, the solid electrolyte material may be essentially free of LiX, such as LiCl and LiBr.

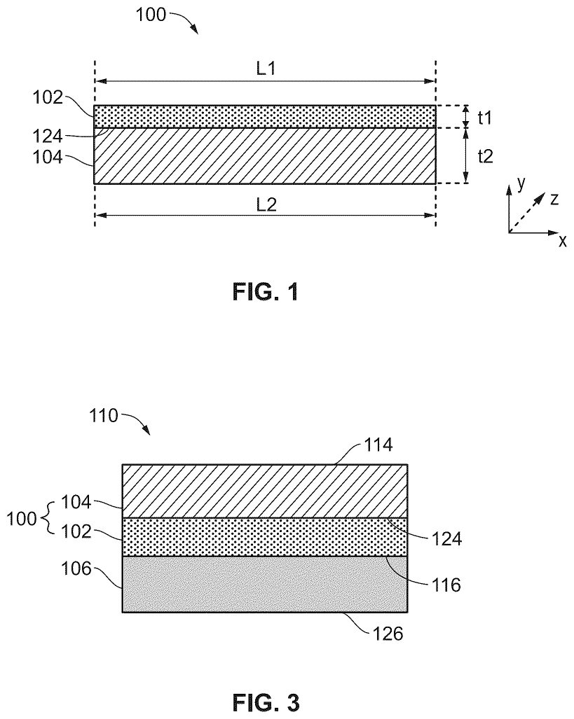

Referring to FIG. 1, a cross sectional of a solid electrolyte material 100 is illustrated including a first solid electrolyte material 102 overlying the second solid electrolyte layer 104. As illustrated, the first solid electrolyte material 102 and the second solid electrolyte material 104 may be in the form of layers made of the first solid electrolyte material and the second solid electrolyte material, respectively. The layer of the first solid electrolyte material 102 and the second solid electrolyte material 104 may be a film, a tape, a block, a sheet, or the like.

The first solid electrolyte material 102 may include a length L1 extending in the longitudinal direction of the first solid electrolyte material 102 or the x-axis and a thickness t1 extending in in the stacking direction of the first and second solid electrolyte materials 102 and 104 or the y-axis that may be perpendicular to the length L1. The second solid electrolyte material 104 may include a length L2 extending in the longitudinal direction of the second solid electrolyte material 104 or x-axis and a thickness t2 extending in in the stacking direction that may be perpendicular to the length L2 or y-axis.

In a particular example, L1 may be substantially the same as L2, such as a difference between L1 and L2 may be within 8% of the greater of L1 and L2, within 5%, within 3%, within 2%, within 1%, or within 0.5% the greater of L1 and L2. In another particular example, the first solid electrolyte material 102 may overly greater than 50% of the surface area of the surface 124, such as at least 60%, at least 70%, at least 85% of the surface area of the surface 124, at least 90%, at least 95%, at least 97%, or at least 99% of the surface area of the surface 124.

As illustrated in FIG. 1, the first solid electrolyte material 102 may be in direct contact with the second electrolyte material 104. In particular examples, the first solid electrolyte material 102 may be in direct contact with a majority of the surface 124 or substantially the entire surface 124.

Referring to FIG. 3, a cross section of a structure 110 is illustrated including the solid electrolyte material 100 illustrated in FIG. 1 and a layer 106. In an embodiment, the layer 106 may include an electrode active material. For example, the layer 106 may include an anode active material, such as Li, In, graphite, Si, or any combination thereof. In a further example, the layer 106 may include an anode including Li. In another example, the layer 106 may include a cathode active material.

As illustrated in FIG. 3, the second solid electrolyte material 104 may include a major surface 114 opposite the major surface 124. The layer 106 may include a major surface 116 opposite a major surface 126. The first solid electrolyte material 102 may be between the layer 106 and the second solid electrolyte material 104. In a particular embodiment, the first electrolyte material 102 may be configured to be an interphase between the layer 106 and the second solid electrolyte material 104. For example, the first electrolyte material 102 may separate at least a majority of the surface 124 or substantially the entire surface 124 from the layer 106. In a further example, the first electrolyte material 102 may separate at least 60% of the surface 124 from the layer 106, such as at least 70%, at least 85%, at least 90%, at least 94%, at least 98%, or even 100% of the surface 124 from the layer 106.

In a further embodiment, the first solid electrolyte material 102 may be in direct contact with the layer 106. In an example, the first solid electrolyte material 102 may be in contact with at least a portion of the surface 116. In a particular example, the first solid electrolyte material 102 may be in contact with substantially the entire surface 116.

In a further embodiment, the first solid electrolyte material 102 may include a particular thickness t1 that can facilitate improved function and/or properties of the solid electrolyte material. In an example, the first solid electrolyte material 102 can include a thickness of at most 1 micron, such as at most 800 nm, at most 600 nm, at most 400 nm, at most 300 nm, at most 200 nm, at most 100 nm, at most 90 nm, at most 80 nm, at most 70 nm, at most 60 nm, at most 50 nm, at most 40 nm, at most 30 nm, at most 20 nm, at most 10 nm, at most 9 nm, at most 8 nm, at most 6 nm, or at most 4 nm. In another example, the first solid electrolyte material 102 may include a thickness t1 of at least 1 nm, at least 3 nm, at least 5 nm, at least 7 nm, at least 10 nm, at least 15 nm, at least 20 nm, at least 30 nm, at least 40 nm, at least 50 nm, at least 60 nm, at least 70 nm, at least 80 nm, at least 90 nm, at least 110 nm, at least 130 nm, at least 150 nm, at least 170 nm, or at least 200 nm. Moreover, the first solid electrolyte material 102 may include a thickness in a range including any of the minimum and maximum values noted herein. For example, t1 may be in a range including at least 1 nm and at most 1 micron or in a range including at least 2 nm and at most 400 nm.

In a further embodiment, the second solid electrolyte material 104 may include a particular thickness t2 that may facilitate improved function and/or properties of the solid electrolyte material. In an example, the second solid electrolyte material 104 can include a thickness of at most 1.3 mm, such as at most 1 mm, at most 900 microns, at most 800 microns, at most 700 microns, at most 600 microns, at most 500 microns, at most 400 microns, at most 300 microns, at most 200 microns, at most 100 microns, at most 80 microns, at most 70 microns, at most 50 microns, or at most 30 microns. In another example, the second solid electrolyte material 104 may include a thickness t2 of at least 10 microns, at least 15 microns, at least 20 microns, at least 30 microns, at least 40 microns, at least 50 microns, at least 60 microns, at least 70 microns, at least 80 microns, at least 90 microns, at least 100 microns, at least 200 microns, at least 300 microns, at least 400 microns, at least 500 microns, at least 600 microns, at least 700 microns, or at least 800 microns. Moreover, the second solid electrolyte material 104 may include a thickness t2 in a range including any of the minimum and maximum values noted herein. For example, t2 may be in a range including at least 1 nm and at most 800 nm or in a range including at least 10 microns and at most 1 mm.

In a further embodiment, the solid electrolyte material may include a particular ratio of t1 to t2, t1/t2, that may facilitate improved function and/or properties of the solid electrolyte material. In an example, the ratio t1/t2 may be at least 0.00001, such as at least 0.0001, at least 0.001, at least 0.005, at least 0.01, at least 0.05, at least 0.1, at least 0.2, at least 0.3, at least 0.4, at least 0.5, at least 0.6, at least 0.7, at least 0.8, or at least 1. In another instance, the ratio t1/t2 may be at most 10, such as at most 8, at most 6, at most 3, at most 1, at most 0.1, at most 0.07, at most 0.05, at most 0.03, at most 0.01, at most 0.005, at most 0.001, at most 0.0005, or at most 0.0001. Moreover, the ratio t1/t2 may be in a range including any of the minimum and maximum values noted herein.

In a further embodiment, the solid electrolyte material may include coated particles including a coating overlying a core. In another embodiment, the solid electrolyte material may be in the form of powder, suspension, slurry, or the like including coated particles. In a particular embodiment, the coating may include the first solid electrolyte material overlying the core including the second solid electrolyte material.

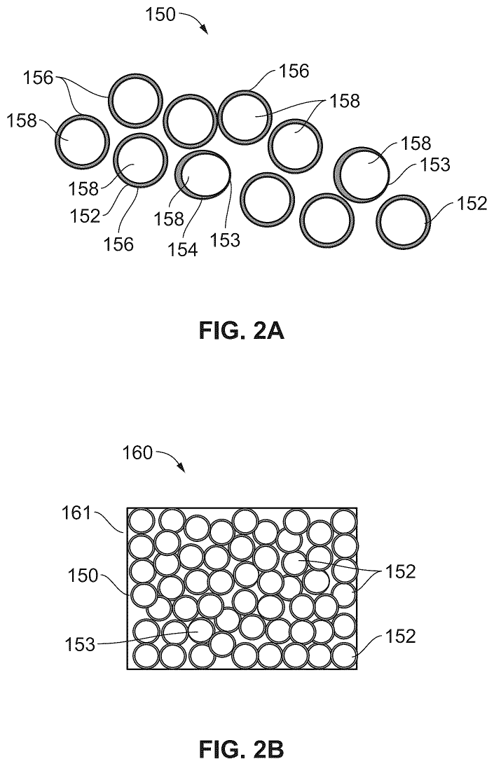

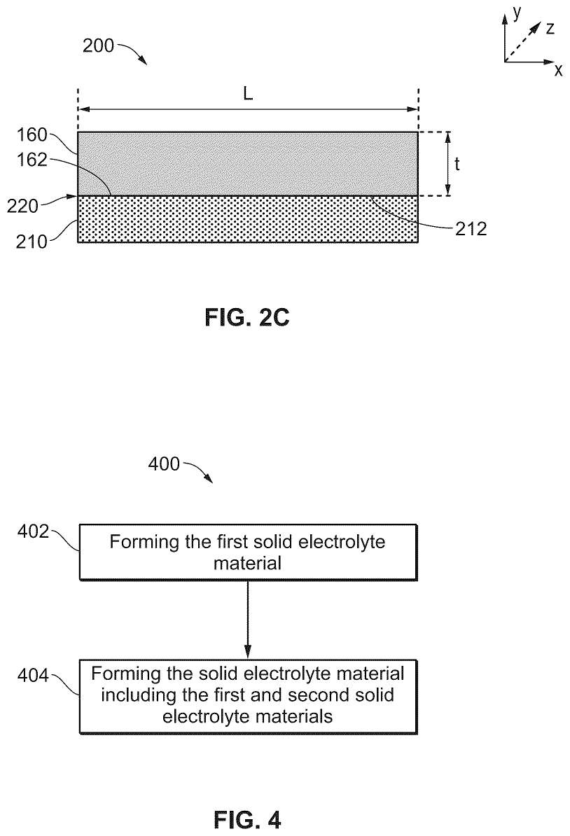

Referring to FIG. 2A, a portion of an exemplary solid electrolyte material 150 is illustrated including coated particles 152 including coating 156 overlying core 158. The coating 156 may be in direct contact with the cores 158. The coating 156 may essentially cover the cores 108 entirely. The particles 156 may have a substantially uniform coating thickness.

In another embodiment, the solid electrolyte material 150 may include coated particles having a coating thickness variation. For example, a portion of the coating may be thicker or thinner comparing to another portion of the coating overlying a core. As illustrated, coated particles 153 may include a coating 154 overlying a core 158, wherein the coating 154 has a thickness variation.

In another embodiment, coated particles may include partially coated particles, fully coated particles, or any combination thereof. In a further embodiment, the solid electrolyte material may include partially and/or fully coated particles that may have a substantially uniform coating thickness.

In an embodiment, the solid electrolyte material 150 may include coated particles including a particular average coating thickness that may facilitate improved performance and/or property of the solid electrolyte material. In an aspect, the average coating thickness may be less than one micron. For example, the coating may have an average thickness of at most 800 nm, such as at most 500 nm, at most 300 nm, at most 100 nm, at most 80 nm, at most 70 nm, at most 60 nm, at most 50 nm, at most 40 nm, at most 30 nm, or at most 20 nm. In another example, the coating may have an average thickness of at least 1 nm, such as at least 2 nm, at least 5 nm, at least 7 nm, at least 10 nm, at least 13 nm, at least 15 nm, at least 18 nm, or at least 20 nm. Moreover, the coating may have an average thickness in a range including any of the minimum and maximum values noted herein.

As used herein, average thickness of the coating may be determined by utilizing transmission electron microscopy to analyze a sample of the solid electrolyte material having a sample size statistically significant to represent the solid electrolyte material.

In an embodiment, the solid electrolyte material 150 may include coated particles including a particular average coating coverage that may facilitate improved performance and/or property of the solid electrolyte material. For example, the average coating coverage may be at least 20% of the surface area of the core, such as at least 30%, at least 40%, at least 50%, at least 60%, at least 70%, at least 80%, at least 90%, or at least 94% of the surface area of the core. In a further example, the coating may cover essentially the entire surface of the core. In another example, the average coating coverage may be not greater than 99% of the surface area of the core, not greater than 96%, not greater than 90%, not greater than 88%, not greater than 85%, or not greater than 80% of the surface area of the core. Moreover, the average coating coverage may be in a range including any of the minimum and maximum percentages noted herein.

In an embodiment, the solid electrolyte material 150 may include a particular amount of coated particles that may facilitate improved performance and/or property of the solid electrolyte material. For example, at least 20 wt %, at least 30 wt %, at least 40 wt %, at least 50 wt %, at least 60 wt %, at least 70 wt %, at least 80 wt %, at least 90 wt %, or at least 95 wt % for a weight of the solid electrolyte material may include a coating. In a particular example, essentially all of the particles, such as at least 97 wt % or at least 99 wt % of the weight of the solid electrolyte material may include coated particles. More particularly, 100 wt % of the weight of the solid electrolyte material may include the coated particles. In a further example, the solid electrolyte material may include uncoated particles. For example, not greater than 99 wt % of the weight of the solid electrolyte material may include coated particles, such as not greater than 98 wt %, not greater than 96 wt %, not greater than 94 wt %, not greater than 92 wt %, not greater than 90 wt %, or not greater than 88 wt % of the weight of the solid electrolyte material may include coated particles. Moreover, the amount of the coated particles may be in a range including any of the minimum and maximum percentages noted herein. For example, the solid electrolyte material may include at least 20 wt % and at most 99 wt % of coated particles for the weight of the solid electrolyte material.

In a further embodiment, the solid electrolyte material 150 may include a particular number of coated particles that may facilitate improved performance and/or property of the solid electrolyte material. For example, at least 20% of a total number of particles of the solid electrolyte material may be coated particles, such as at least 30%, at least 40%, at least 50%, at least 60%, at least 70%, at least 80%, at least 90%, or at least 95% of a total number of particles may be coated particles. In a particular example, essentially all particles, such as at least 96% or at least 98% of the total number of particles may be coated particles. More particularly, all particles of the solid electrolyte material may be coated particles. In another example, not greater than 99% of the total number of particles may be coated particles, such as not greater than 98%, not greater than 96%, not greater than 94%, not greater than 92%, not greater than 90%, or not greater than 88% of the total number of particles may be coated particles. Moreover, the solid electrolyte material may include a content of coated particles in a range including any of the minimum and maximum percentages noted herein.

In an embodiment, the content of coated particles may be determined by using focused ion beam-transmission electron microscopy (FIB-TEM) and energy dispersive X-ray analysis (EDX) to analyze cross sections. A solid electrolyte material sample having a sample size statistically representative of the solid electrolyte material can be analyzed by FIB-TEM and EDX. The number or weight of the particles having the coating can be determined based on EDX results. The percentage of the coated particles relative to the total number or weight of the particles that are analyzed can be used as the content of the coated particles for the solid electrolyte material.

In certain instances, the solid electrolyte material 150 may include uncoated particles in addition to coated particles. In an example, a small portion of particles may be uncoated particles, such as cores without coating. In a further example, not greater than 30 wt % for a total weight of the particles may include uncoated particles, such as not greater than 20 wt %, not greater than 10 wt %, not greater than 5 wt %, not greater than 3 wt %, or not greater than 1 wt % of the total weight of the solid electrolyte material may include uncoated particles. In still another embodiment, the solid electrolyte material 150 may include uncoated particles of at most 30% of the total number of particles, such as not greater than 20%, not greater than 10%, not greater than 5%, not greater than 3%, or not greater than 1% of the total number of particles. In a particular embodiment, the solid electrolyte material 150 may be essentially free of uncoated particles. The content of uncoated particles may be determined by using FIB-TEM and EDX in the manner similar to embodiments described with respect to determining the content of particles including the coating.

In an embodiment, the solid electrolyte material 150 may include an average particle size. In an example, the average particle size may be sub-microns to hundreds of microns or even bigger. In another example, the average particle size may be from 1 micron to 500 microns, such as from 10 microns to 300 microns, or from 20 microns to 200 microns. In still another example, the average particle size may be from 1 micron to 10 microns, such as 2 microns to 5 microns. In still another example, the solid electrolyte material 150 may include loose particles, agglomerated particles, aggregates, or any combination thereof.

In an embodiment, the soli electrolyte material 150 may be formed into a certain shape, such as a sheet, a tape, a block, a film, or the like, or any combination. Referring to FIG. 2B, a cross-sectional view of a layer 160 according to an embodiment, including a body 161 including the solid electrolyte material 150. Referring to FIG. 2C, a cross-sectional view of another exemplary structure 200 is illustrated, including the layer 160 overlying a layer 210. In an embodiment, the layer 210 may include an electron conductive material. For example, the electron conductive material can include an active anode material. In a particular example, the layer 210 may include an anode including a lithium ion conductive material. In another example, the layer 210 may include an anode including lithium, Si, graphite, or the like, or any combination thereof.

The layer 160 may include a major surface 162. In an embodiment, at least 50% of the surface area of the major surface 162 may be defined by the coating 154 and/or 152 illustrated in FIG. 2A. In a particular example, at least 60%, at least 70, at least 80%, at least 90%, at least 93%, or at least 95% of the surface area of the major surface 162 may be defined by the coating 154 and/or 152 illustrated in FIG. 2A. In a further example, up to 100% of the surface area of the major surface 162 may be defined by the coating 154 and/or 152 illustrated in FIG. 2A.

In another embodiment, not greater than 40% of the surface area of the major surface 162 may be defined by the core 158 illustrated in FIG. 2A, such as not greater than 30%, not greater than 20%, not greater than 10%, not greater than 5%, or not greater than 2% of the surface area of the major surface 162 may be defined by the core 158 illustrated in FIG. 2A.

The layer 210 may include a major surface 212, wherein at least a portion of the major surface 212 may be in contact with the major surface 162. In a particular example, substantially the entire major surface 212 may be in contact with the major surface 162. In a further embodiment, at least a portion of the layer 210 may be in contact with the coating 154 and/or 152 illustrated in FIG. 2A. In an example, at least 55% of the surface area of the major surface 212 may be in contact with coating 154 and/or 152 illustrated in FIG. 2A, such as at least 60%, at least 70, at least 80%, at least 90%, at least 93%, or at least 95% of the surface area of the major surface 212 may be in contact with the coating 154 and/or 152 illustrated in FIG. 2A. In a further example, up to 100% of the surface area of the major surface 212 may be in contact with the coating 154 and/or 152 illustrated in FIG. 2A.

The structure 200 may include an interface 220 between the layers 160 and 210, defined at least by a portion of the major surface 162 and at least a portion of the major surface 212. In a particular embodiment, at least 55% of the interface 220 may be defined by the coating 154 and/or 152 illustrated in FIG. 2A and the major surface 212, such as at least 60%, at least 70, at least 80%, at least 90%, at least 93%, or at least 95% of the interface 220 may be defined by the major surface 212 and the coating 154 and/or 152 illustrated in FIG. 2A. In a further example, up to 100% of the interface 220 may be defined by the major surface 212 and the coating 154 and/or 152 illustrated in FIG. 2A.

In a particular embodiment, the layer 210 may include an anode active material, wherein at least a portion of the major surface 212 may be defined by the anode active material. In a further embodiment, the anode active material may be in contact with the coating 154 and/or 152 illustrated in FIG. 2A. In particular examples, the coating 154 and/or 152 illustrated in FIG. 2A may serve as an interphase between the anode active material and the core 158 illustrated in FIG. 2A. In more particular examples, the first solid electrolyte material may serve as the interface between the second solid electrolyte material and the anode active material. In another example, at least majority of cores 158 illustrated in FIG. 2A may be separated from the anode active material by the coating 154 and/or 152 illustrated in FIG. 2A, such as substantially or entirely all cores may be separated from the anode active material.

As illustrated in FIG. 2C, the layer 160 may include a length L extending in the longitudinal direction or x-axis and a thickness t extending in in the stacking direction of the layers 160 and 210 or y-axis. In a further embodiment, the layer 160 may include a particular thickness that may facilitate improved function and/or properties of the solid electrolyte material. In an example, the thickness t may be at most 1.3 mm, such as at most 1 mm, at most 900 microns, at most 800 microns, at most 700 microns, at most 600 microns, at most 500 microns, at most 400 microns, at most 300 microns, at most 200 microns, at most 100 microns, at most 80 microns, at most 70 microns, at most 50 microns, or at most 30 microns. In another example, the thickness t may be at least 10 microns, at least 15 microns, at least 20 microns, at least 30 microns, at least 40 microns, at least 50 microns, at least 60 microns, at least 70 microns, at least 80 microns, at least 90 microns, at least 100 microns, at least 200 microns, at least 300 microns, at least 400 microns, at least 500 microns, at least 600 microns, at least 700 microns, or at least 800 microns. Moreover, the layer 160 may include a thickness t in a range including any of the minimum and maximum values noted herein.

In an embodiment, the structure 200 may be a component of an electrochemical device (not illustrated). For example, the electrochemical device may include one or more other components that may overlie at least a portion of the structure 200. In a particular example, a cathode material may overlie the layer 160. In another example, an electrolyte layer may overlic at least a portion of the layer 160. In particular instances, the structure may be a component of a solid-state ion battery, such as a solid-state lithium battery. In a further embodiment, an electrochemical device may include a cell structure including the solid electrolyte material 100 or 150 illustrated in FIG. 1 or 2A respectively, between a cathode and an anode, wherein the first solid electrolyte material may be adjacent the anode and distal from the cathode. In particle examples of cell structures, the first solid electrolyte material may be in contact with the anode, and the second solid electrolyte material may be adjacent the cathode and distal from the anode.

In an embodiment, a cell structure may include the solid electrolyte material 100 or 150 illustrated in FIG. 1 or 2A respectively, and an anode including an anode active material, such as an alkali metal including Li, graphite, Si, or the like, or any combination thereof, wherein the first solid electrolyte material may be in contact with the anode. In particular examples, the anode may include an alkali metal including, for example, Li, and more particularly, the first solid electrolyte material may be in contact with the alkali metal including Li. The cell structure may have improved cell performance, such as discharge capacities, comparing to a corresponding cell structure in which the first solid electrolyte or the second solid electrolyte material may be used in lieu of the solid electrolyte material. In particular examples, the cell structure including the solid electrolyte material of 100 or 150 illustrated in FIG. 1 or 2A respectively, may include discharge capacities of greater than 4 mAh g⁻¹, such as at least 10 mAh g⁻¹, at least 20 mAh g⁻¹, at least 40 mAh g⁻¹, at least 50 mAh g⁻¹, at least 60 mAh g⁻¹, at least 80 mAh g⁻¹, at least 90 mAh g⁻¹, at least 100 mAh g⁻¹, at least 110 mAh g⁻¹, at least 120 mAh g⁻¹, at least 130 mAh g⁻¹, or at least 140 mAh g⁻¹. In another example, the discharge capacities may be not greater than 220 mAh g⁻¹, not greater than 210 mAh g⁻¹, not greater than 200 mAh g⁻¹, not greater than 190 mAh g⁻¹, not greater than 180 mAh g⁻¹, not greater than 170 mAh g⁻¹, not greater than 160 mAh g⁻¹, not greater than 150 mAh g⁻¹, or not greater than 140 mAh g⁻¹. Moreover, the discharge capacities may be in a range including any of the minimum and maximum values noted herein.

As used herein, discharge capacities may be determined by testing galvanostatic cycling performance of a cell structure. The cell structure may include in the stacking direction, a current collector, a cathode layer, the solid electrolyte material, and a lithium metal anode. The cathode layer can be formed by making a mixture of % 60 (w/w) of LiNi_{0.6}Mn_{0.2}Co_{0.2}O (also referred to as NMC 622) and % 40 (w/w) of Li₃Y(Br_{0.2}Cl_{0.8})₆ and adding % 0.5 (w/w) of vapor grown carbon fiber (VGCF) to the mixture. The mixture can be further mixed with toluene and roller mixed for 4 days before toluene is evaporated from the cathode mixture by heating the mixture on the top of a hot plate at 95° C. The cathode mixture can then be pressed on the top of the solid electrolyte material (the second solid electrolyte material) with 40 bar. Li anode can be put on the other side of the solid electrolyte material. The cell structure can be then assembled using a 3.0 N·m torque force and then tested with the constant current of 0.05C over the potential range of 0-4.3 V versus Li metal anode.

In another embodiment, the solid electrolyte material 150 may be formed into a composite layer. For example, a composite layer may include the solid electrolyte material 150 and an electron conductive material including, for example, an anode active material, a cathode active material, an electron conductive additive, or the like, or combinations thereof. In another example, the composite layer may include mixed ionic conductivity and electron conductivity. In another example, the composite layer may include an anolyte, a catholyte, or the like.

In an embodiment, the solid electrolyte material can have improved ionic conductivity. In an example, the solid electrolyte material can have a bulk ionic conductivity of at least 0.001 mS/cm, at least 0.01 mS/cm, at least 0.1 mS/cm, at least 0.5 mS/cm, at least 1 mS/cm, or at least 2 mS/cm. In another example, the solid electrolyte material can have a bulk ionic conductivity of at most 3 mS/cm, at most 2.5 mS/cm, or at most 2.2 mS/cm. Moreover, the solid electrolyte material may have a bulk ionic conductivity in a range including any of the minimum and maximum values noted herein.

Referring to FIG. 4, a process 400 is illustrated. The process 400 may start at block 402, forming the first solid electrolyte material. In an embodiment, a mixture including reactants may be formed. In an example, reactants may include one or more of alkali fluoride (MF), alkali halides other than fluorides (MX, wherein X may be Br, Cl, or I), and alkali hydroxides (MOH). In a further example, the mixture may be dry or wet. In another example, reactants may be in the form of powder, sol-gel, non-aqueous solution or suspension, or any combination thereof. In another example, reactants may be mixed at a stoichiometric ratio, non-stoichiometric ratio, or a combination thereof.

In an embodiment, the mixture may include a particular concentration of MF, such as LiF, to facilitate improved formation and/or property and performance of the solid electrolyte material. For example, the concentration of MF may be adjusted to have a particular ratio of C_{MOX}/C_{MOHX}, help minimize formation of MX, wherein X may be Br, Cl, or I. In another example, concentration of MF may be controlled to facilitate formation of the first solid electrolyte material having improved property and/or performance including improved impedance, the oxidation/reduction stability, bulk ionic conductivity, or any combination thereof.

Increased concentration of MF in the mixture may facilitate increased formation of the metal oxide halide and alkali metal halide other than fluoride. In an embodiment, the mixture may include a particular concentration of MF that may facilitate improved formation of the metal oxide and controlled formation of alkali metal halide other than fluoride. In an example, the mixture may include at least 1 mol % of MF relative to MOH, such as at least 6 mol %, at least 9 mol %, at least 11 mol %, at least 12 mol %, at least 14 mol %, at least 17 mol %, at least 20 mol %, at least 22 mol %, at least 25 mol %, at least 28 mol %, or at least 30 mol % of MF relative to MOH. Alternatively or additionally, the mixture may include not greater than 35 mol % of MF relative to MOH, such as not greater than 31 mol %, not greater than 29 mol %, not greater than 26 mol %, not greater than 23 mol %, not greater than 20 mol %, not greater than 17 mol %, not greater than 13 mol %, not greater than 11 mol %, or not greater than 9 mol % relative to MOH. Moreover, the mixture may include a concentration of MF in a range including any of the minimum and maximum percentages noted herein.

In an embodiment, the mixture may be heated to form the first electrolyte material. Heating may be facilitated by a heating device, such as a furnace, heater plate, or the like. In an embodiment, heating may be performed in a particular environment to facilitate reactions of the mixture. In an example, heating may be conducted in dry ambient, or in an inert atmosphere. In a further example, heating may be performed in an atmosphere having a particular pressure, such as higher or lower than the atmosphere pressure. In another instance, heating may be conducted in air.

In an embodiment, the mixture may be heated at a particular temperature that may facilitate improved formation of the first solid electrolyte material. In an aspect, the temperature can be controlled to be below the melting temperature of the first solid electrolyte material. In another aspect, the heating temperature may be controlled to facilitate reactions between the reactants. For example, the heating temperature can be adjusted by taking into consideration of compositions of reactants, kinetics of reactions, reaction rate, reaction time, or any combination thereof.

In a particular example, heating may be conducted at a temperature of at least 250° C., such as at least 260° C., at least 280° C., at least 300° C., at least 315° C., at least 320° C. Additionally or alternatively, heating may be conducted at a temperature of not greater than 330° C., such as not greater than 320° C., not greater than 270° C., not greater than 260° C., not greater than 250° C., or not greater than 240° C. Moreover, heating may be conducted at a temperature in a range including any of the minimum and maximum temperatures noted herein.

In another embodiment, the mixture may be heated for a particular period of time that may facilitate improved formation of the first solid electrolyte material. In an example, a relatively higher temperature may be applied for a relatively shorter time. Alternatively, a lower temperature may be used with a relatively longer heating time. In another example, heating time can be adjusted taking into consideration of compositions of the reactants, concentrations of reactants, and/or other reaction conditions.

In an example, heating may be performed for at least 25 minutes, such as at least 30 minutes, at least 40 minutes, at least 50 minutes or at least 60 minutes. In another example, heating may be performed for not greater than 90 minutes, such as not greater than 80 minutes, not greater than 70 minutes, not greater than 60 minutes, not greater than 50 minutes, or not greater than 40 minutes. Moreover, heating may be conducted for a time period in a range including any of the minimum and maximum values noted herein.

In exemplary implementations, forming the first solid electrolyte material may include monitoring chemical reactions to facilitate improved formation of the first solid electrolyte material. For example, formation of phase compositions of the first solid electrolyte material may be confirmed by X-ray diffraction. In another example, uniformity and/or completeness of reactions may be monitored and/or examined by utilizing optical microscope, scanning electron microscopy, energy dispersive X-ray spectroscopy, X-ray photoelectron spectroscopy (XPS), or the like, or a combination thereof.

In an exemplary implementation, a mixture may be formed by mixing powder materials of LiF, LiBr, and LiOH at a stoichiometric ratio with aid of a mixing device, such as a mortar and pestle. Mixing may be performed for 5 to 30 minutes or otherwise until a homogenous mixture is formed. After mixing, the mixture may be transferred to a muffle furnace for the heat treatment at 320° C.-360° C. for 40-60 minutes to obtain the first solid electrolyte including Li₂OHBr and Li₇O₂Br₃.

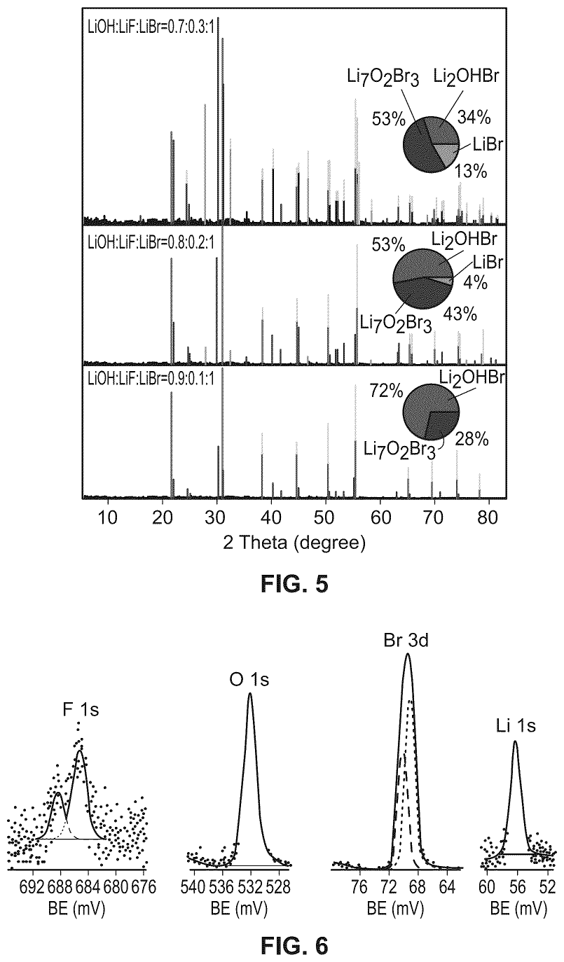

FIG. 5 includes test results of X-ray diffraction analysis of representative first solid electrolyte materials formed by including LiF at different concentrations. As illustrated, when the mole ratio of LiOH:LiF:LiBr is 0.7:0.3:1, the synthesized first solid electrolyte material may include the crystalline phase of Li₇O₂Br₃ of 53 wt %, the crystalline phase of Li₂OHBr of 34 wt %, and the crystalline phase of LiBr of 13% for a total weight of all the crystalline phases. When the mole ratio of LiOH:LiF:LiBr is 0.8:0.2:1, the synthesized first solid electrolyte material may include the crystalline phase of Li₇O₂Br₃ of 43 wt % of Li₇O₂Br₃, the crystalline phase of Li₂OHBr of 53 wt %, and the crystalline phase of LiBr of 4% for a total weight of all the crystalline phases. When the mole ratio of LiOH:LiF:LiBr is 0.9:0.1:1, the synthesized first solid electrolyte material may include the crystalline phase of Li₇O₂Br₃ of 28 wt %, and the crystalline phase of Li₂OHBr of 72 wt % for a total weight of all the crystalline phases.

FIG. 6 includes test results of XPS analysis of a representative first solid electrolyte material. As indicated by the test results, the first solid electrolyte material may include Li, O, Br, and F species. The deconvoluted high resolution Is spectrum of fluorine includes two peaks at approximate 685 eV and 689 eV, which may indicate presences of two different fluorine species. The peak at the binding energy of approximate 685 CV may suggest a metal-fluorine bond, and the peak at the binding energy of 689 eV may represent an oxyfluoride species.

The process 400 may continue to form the solid electrolyte material at block 404. In an embodiment, the first solid electrolyte material may be disposed over the second solid electrolyte material. In an embodiment, the first solid electrolyte material may be applied to the second electrolyte material by brushing, pressing, spraying, injecting, dip-coating, or any combination thereof. For example, the first solid electrolyte material may be aerosol-sprayed onto the second electrolyte material. In another example, the second electrolyte material may be dip-coated by immersing the second electrolyte material in the first solid electrolyte material. In an embodiment, forming the solid electrolyte material may include heating, pressing, polishing, grinding, molding, milling, cutting, or any combination thereof to form the solid electrolyte material in the desired form.

In another example, the first solid electrolyte material may be disposed over at least a portion of at least one of the major surfaces of a layer of the second electrolyte material. A layer of the second electrolyte material may be formed by casting, compacting, cold pressing, warm pressing, or another technique known in the art. In an example, the first solid electrolyte material may be pre-shaped into a film, a sheet, a block, or the like before being disposed onto the second solid electrolyte material. In another example, the first solid electrolyte material may be shaped while or after being applied to the second solid electrolyte material. In a further example, one or more of an organic material, such as a binder material, a solvent, a dispersant, a surfactant, or the like, or any combination thereof may be used to facilitate formation of the solid electrolyte material in a desired form. In at least one example, one or more of the organic materials may be partially or entirely removed from the finally formed solid electrolyte material.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. A solid electrolyte material, comprising:
a first solid electrolyte material overlying at least a portion of a second solid electrolyte material,
wherein the first solid electrolyte material comprises MaMefObXc, wherein M comprises an alkali metal, X comprises a halogen, 0≤f≤1, a/b>3, c=a+ (k×f)−2b, k is a valence of Me, and Me comprises a metal different from M; and
wherein the second solid electrolyte material comprises a halide.

Embodiment 2. The solid electrolyte material of embodiment 1, wherein M includes Li, Na, or a combination thereof.

Embodiment 3. The solid electrolyte material of embodiment 1 or 2, wherein X comprises at least one of Cl or Br.

Embodiment 4. The solid electrolyte material of any one of embodiments 1 to 3, wherein X comprises Br, and M comprises Li.

Embodiment 5. The solid electrolyte material of any one of embodiments 1 to 4, wherein the first solid electrolyte material further comprises a first crystalline phase including MₐMe_{f}O_{b}X_{c} and a second crystalline phase including M′ₘ(Me′)_{f′}(OH)ₙX′ₚ, wherein M′ comprises an alkali metal, X′ comprises a halogen, 1≤m≤5, 0≤f′≤1, 1≤n≤4, p=m+ (k′×f)−n, k′ is a valence of Me′, and Me′ comprises a metal different from M′.

Embodiment 6. The solid electrolyte material of embodiment 5, wherein M′ and M include a same alkali metal element.

Embodiment 7. The solid electrolyte material of embodiment 5 or 6, wherein M′ includes Li, Na, or a combination thereof.

Embodiment 8. The solid electrolyte material of any one of embodiments 5 to 7, wherein X′ comprises at least one of Cl or Br.

Embodiment 9. The solid electrolyte material of any one of embodiments 5 to 7, wherein X′ comprises Br, and M′ comprises Li.

Embodiment 10. The solid electrolyte material of any one of embodiments 5 to 9, wherein the first solid electrolyte material comprises a weight content ratio of the first crystalline phase to the second crystalline phase, C_{MOX}/C_{MOHX}, of at least 0.05, at least 0.07, at least 0.10, at least 0.13, at least 0.15, at least 0.18, at least 0.20, at least 0.23, at least 0.25, at least 0.28, at least 0.30, at least 0.32, at least 0.34, at least 0.36, at least 0.38, or at least 0.40, wherein C_{MOX} is a weight content of MₐMe_{f}O_{b}X_{c} for a total weight of the first solid electrolyte material; and C_{M′OHX′} is a weight content of M′ₘ(Me′^{k+})_{f′}(OH)ₙX′ₚ for the total weight of the first solid electrolyte material.

Embodiment 11. The solid electrolyte material of embodiment 10, wherein the weight content ratio, C_{MOX}/C_{MOHX}, is not greater than 100, not greater than 50, not greater than 20, not greater than 10, not greater than 6, not greater than 3, not greater than 2, not greater than 1, not greater than 0.90, not greater than 0.80, not greater than 0.70, not greater than 0.60, not greater than 0.50, or not greater than 0.40.

Embodiment 12. The solid electrolyte material of any one of embodiments 1 to 11, wherein the first solid electrolyte material comprises a first crystalline phase including Li₇O₂X₃.

Embodiment 13. The solid electrolyte material of any one of embodiments 1 to 12, wherein the second solid electrolyte material comprises a second crystalline phase including Li₂OHX.

Embodiment 14. The solid electrolyte material of any one of embodiments 1 to 12, wherein the first solid electrolyte material comprises a second crystalline phase including Li₄(OH)₃X.

Embodiment 15. The solid electrolyte material of any one of embodiments 1 to 13, wherein the first solid electrolyte material comprises a third crystalline phase including Li₄(OH)₃X.

Embodiment 16. The solid electrolyte material of any one of embodiments 1 to 15, wherein the first solid electrolyte material comprises a dopant including fluorine.

Embodiment 17. The solid electrolyte material of embodiment 16, wherein the dopant comprises a fluoride, an oxyfluoride, or any combination thereof.

Embodiment 18. The solid electrolyte material of any one of embodiments 1 to 17, wherein the halide comprises M″_{3-z}(Me″)_{f″}X″_{3-z+k″**f″}, wherein −3≤z<3, 0<f″≤1, M″ comprises an alkali metal element, k″ is a valence of Me″, Me″ comprises a metal different from M″; and X″ comprises a halogen.

Embodiment 19. The solid electrolyte material of any one of embodiments 1 to 18, wherein the halide material comprises at least two halogens selected from the group consisting of F, Cl, Br, and I; and wherein M″ comprises Li.

Embodiment 20. The solid electrolyte material of any one of embodiments 1 to 19, wherein the halide is represented by Li₃₋ₓRE_{1-y}Me″^{k″}_{y}(Cl₁₋ᵤBrᵤ)_{6-x+y*(k″-3)}, wherein 0.08<=u<=0.67.

Embodiment 21. The solid electrolyte material of any one of embodiments 1 to 20, wherein the first or second solid electrolyte material is in a form of a film, a tape, a block, a sheet, or any combination thereof.

Embodiment 22. The solid electrolyte material of any one of embodiments 1 to 21, wherein the first solid electrolyte material is in direct contact with at least the portion of the second solid electrolyte material.

Embodiment 23. The solid electrolyte material of any one of embodiments 1 to 20, wherein the solid electrolyte material is in a form of coated particles including a coating including the first solid electrolyte material in direct contact with a core including the second solid electrolyte material.

Embodiment 24. The solid electrolyte material of any one of embodiments 1 to 23, wherein the second solid electrolyte material has a thickness, t2, of not greater than 10 microns to 1 mm.

Embodiment 25. The solid electrolyte material of embodiment 24, wherein the first solid electrolyte material has a thickness, t1, of at least 1 nm and at most 100 nm.

Embodiment 26. The solid electrolyte material of embodiment 25, wherein a ratio of t1/t2 is at least 0.0001 and at most 10.

Embodiment 27. The solid electrolyte material of any one of embodiments 1 to 26, wherein the first solid electrolyte material is essentially free of a crystalline phase including LiF.

Embodiment 28. A structure, comprising:
a solid electrolyte layer including the solid electrolyte material of any one of embodiments 1 to 27; and
an anode overlying the solid electrolyte layer,
wherein the first solid electrolyte material is between the anode and the second solid electrolyte material.

Embodiment 29. The structure of embodiment 28, wherein the first solid electrolyte material is configured to be an interfacial layer separating the second electrolyte material from the anode, wherein the first solid electrolyte material is configured to separate the second solid electrolyte material from the anode entirely.

Embodiment 30. The structure of embodiment 28 or 29, wherein the first solid electrolyte material is in direct contact with the anode.

Embodiment 31. The structure of any one of embodiments 28 to 30, further comprising a cathode overlying the solid electrolyte layer.

Embodiment 32. A solid electrolyte material, comprising a polycrystal comprising A_{q} and B_{(1-q)}, wherein:
A is present in a first crystalline phase represented by MₐMe_{f}O_{b}X_{c}, wherein
   M comprises an alkali metal;
   X comprises a halogen;
   Me comprises a divalent metal element, a trivalent metal element, a tetravalent metal element, a pentavalent metal element, a hexavalent metal element, or any combination thereof;

$$\begin{matrix}0 \leq f \leq 1 ; \\ a / b > 3 ; \\ c = a + ( k \times f ) - 2 b ;\end{matrix}$$

and
k is a valence of Me;
B is present in a second crystalline phase represented by M′ₘ(Me′)_{f′}(OH)ₙX′ₚ, wherein:
   M′ comprises an alkali metal;
   X′ comprises a halogen;
   Me′ comprises a divalent metal element, a trivalent metal element, a tetravalent metal element, a pentavalent metal element, a hexavalent metal element, or any combination thereof;

$$\begin{matrix}1 \leq m \leq 5 ; \\ 0 \leq f ’ \leq 1 ; \\ 1 \leq n \leq 4 ; \\ p = m + ( k ’ \times f ’ ) - n ;\end{matrix}$$

and
k′ is a valence of Me′; and
wherein the polycrystal comprises a dopant including fluorine.

Embodiment 33. The solid electrolyte material of embodiment 32, wherein M′ and M include a same alkali metal element.

Embodiment 34. The solid electrolyte material of embodiment 32 or 33, wherein M and M′ independently include Li, Na, or a combination thereof.

Embodiment 35. The solid electrolyte material of any one of embodiments 32 to 34, wherein X and X′ independently comprise at least one of Cl or Br.

Embodiment 36. The solid electrolyte material of any one of embodiments 32 to 35, wherein each of X and X′ comprises Br; and each of M and M′ comprises Li.

Embodiment 37. The solid electrolyte material of any one of embodiments 32 to 36, wherein q is at least 0.05, at least 0.07, at least 0.10, at least 0.13, at least 0.15, at least 0.18, at least 0.20, at least 0.23, at least 0.25, or at least 0.28.

Embodiment 38. The solid electrolyte material of embodiment 37, wherein q is not greater than 0.95, not greater than 0.90, not greater than 0.85, not greater than 0.80, not greater than 0.75, not greater than 0.70, not greater than 0.65, not greater than 0.60, not greater than 0.55, not greater than 0.50, not greater than 0.45, not greater than 0.40, not greater than 0.35, not greater than 0.30, not greater than 0.28, or not greater than 0.25.

Embodiment 39. The solid electrolyte material of any one of embodiments 32 to 38, wherein A comprises Li₇O₂X₃.

Embodiment 40. The solid electrolyte material of any one of embodiments 32 to 39, wherein B comprises Li₂OHX′.

Embodiment 41. The solid electrolyte material of any one of embodiments 32 to 39, wherein B comprises Li₄(OH)₃X′.

Embodiment 42. The solid electrolyte material of any one of embodiments 32 to 40, wherein the polycrystal comprises a third crystalline phase including Li₄(OH)₃X′.

Embodiment 43. The solid electrolyte material of any one of embodiments 32 to 42, wherein the dopant comprises a fluoride, an oxyfluoride, or any combination thereof.

Embodiment 44. The solid electrolyte material of any one of embodiments 1 to 43, wherein the solid electrolyte material is essentially free of LiCl and LiBr.

Embodiment 45. The structure of any one of embodiments 28 to 30, wherein the anode comprises an alkali metal, graphite, In, Si, or any combination thereof.

### EXAMPLES

### Example 1

Li₂OHBr is synthesized as follows. A stoichiometric ratio of LiBr and LiOH powders are mixed and ground using a mortar and pestle. After grinding for 15 min, the powder mixture is transferred to a muffle furnace and heat-treated at 350° C. for 1 hour to obtain Li₂OHBr powder.

Cell Sample CS1 is formed. Li₂OHBr powder of 6 mg is applied to fully cover the surface of a pellet of a halide material, Li—Y—Br—Cl. Then halide material pellet is pressed with Li₂OHBr at 30 bar to obtain a compressed pellet. A cathode composite is prepared by pre-mixing of % 60 (w/w) of NMC622 with % 40 (w/w) of the halide material and adding vapor grown carbon fiber (VGCF) of % 0.5 (w/w) to the pre-mixture. The mixture is mixed with toluene and roller mixed for 4 days. Toluene is then evaporated by heating the mixture at 95° C. The cathode composite is then pressed on the top of the halide material with 40 bar. Li anode is put on top of Li₂OHBr. The cell is then assembled using a 3.0 N·m torque force.

The prepared cell is tested for galvanostatic cycling performance with the constant current of 0.05C over the potential range of 0-4.3 V versus Li metal anode.

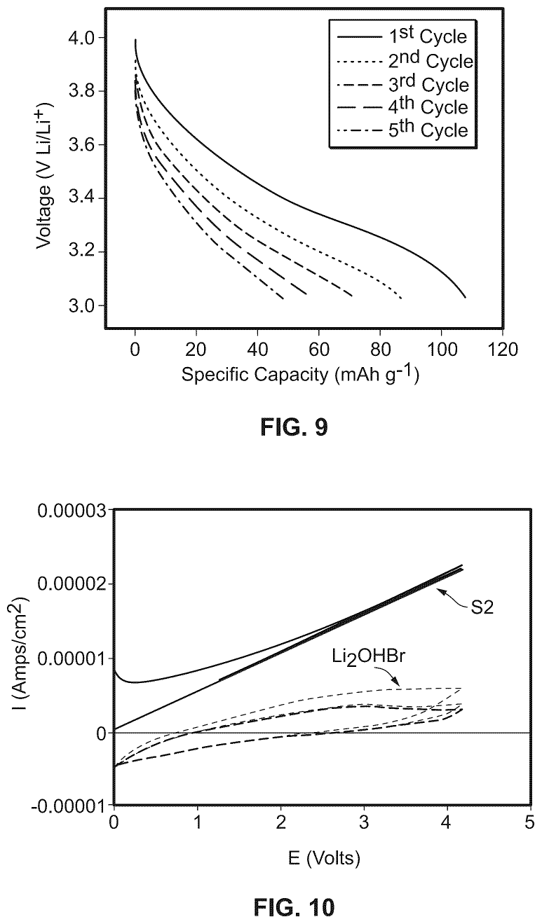

FIG. 9 includes a plot of voltage vs. specific capacity of the first 5 charge/discharge cycles tested on the cell CS1. As indicated, the discharge capacity drops significantly in the first 5 cycles. The decay of the discharge capacity may indicate some instability Li₂OHBr and/or the halide material at the anode side.

### Example 2

Representative first solid electrolyte materials including mixed phases of Li₂OHBr and Li₇O₂Br₃ are synthesized according to embodiments herein. In brief, powders of LiF, LiBr, and LiOH are mixed at different ratios using the same mixing conditions as described in Example 1. The mixtures are than heated at 350° C. for 1 hour to form the first solid electrolyte materials.

Sample S2 is formed using the mole ratio of LiOH:LiF:LiBr of 0.9:0.1:1.

Sample S3 is formed using the mole ratio of LiOH:LiF:LiBr of 0.8:0.2:1.

Sample S4 is formed using the mole ratio of LiOH:LiF:LiBr of 0.7:0.3:1.

Sample S5 is formed using the mole ratio of LiOH:LiF:LiBr of 0.6:0.4:1.

The XRD patterns of the first solid electrolyte materials S2-S4 are illustrated in FIG. 5 and XPS analysis of Sample S2 is included in FIG. 6, both of which are described earlier.

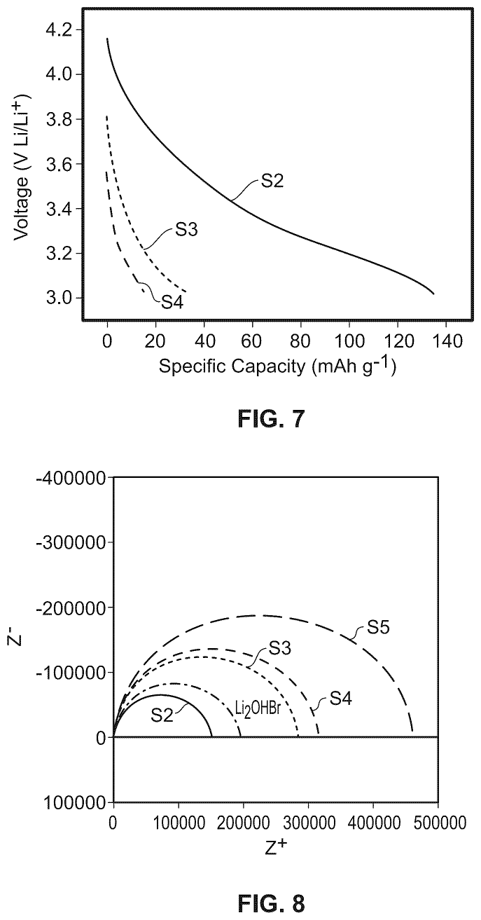

FIG. 7 includes a plot of voltage vs. specific capacity of the first charge/discharge cycle tested on the first solid electrolyte materials S2-S4. The galvanostatic cycling is performed using the same conditions described in Example 1. The sample formed by the ratio of LiOH:LiF:LiBr of 0.9:0.1:1 demonstrates improved discharge capacity compared to samples formed by the ratio LiOH:LiF:LiBr of 0.8:0.2:1 and LiOH:LiF:LiBr of 0.7:0.3:1. The sample formed by the ratio of LiOH:LiF:LiBr of 0.8:0.2:1 demonstrates improved discharge capacity compared to the sample formed by the ratio of LiOH:LiF:LiBr of 0.7:0.3:1.

FIG. 8 includes an illustration of electrochemical impedance spectroscopy (EIS) spectra of the first solid electrolyte materials S2 to S5 and Li₂OHBr. Sample S2 (formed using the ratio of LiOH:LiF:LiBr of 0.9:0.1:1) demonstrated improved bulk ionic conductivity than Li₂OHBr (sample formed by LiOH and LiBr), 9.3×10⁻⁴ mS/cm vs. 6.2×10 mS/cm. Samples S3-S5 demonstrated further decreased bulk ionic conductivity and increased impedance, which may be due to the existence of residual LiBr.

Cyclic voltammogram (CV) of the first 5 charge/discharge cycles of Li₂OHBr and Sample S2 is illustrated in FIG. 10. Scan rate of 1 mv/second is used. Cell CS6 with the configuration Li/Li₂OHBr/Li₂OHBr-VGCF/Stainless steel and Cell S7 with the configuration of Li/Sample S2/Sample S2-VGCF/Stainless steel is used in the tests. As illustrated, Cell S7 does not demonstrate any redox reaction, while the CV of Li₂OHBr vs. Li metal anode represents a hysteresis that confirms the existence of redox phenomena when the potential is scanned from 0 to 4.3 V vs. Li/Lit. The data suggests higher conductivity and better stability of Sample S2 when used in contact with Li metal anode compared to Li₂OHBr.

### Example 3

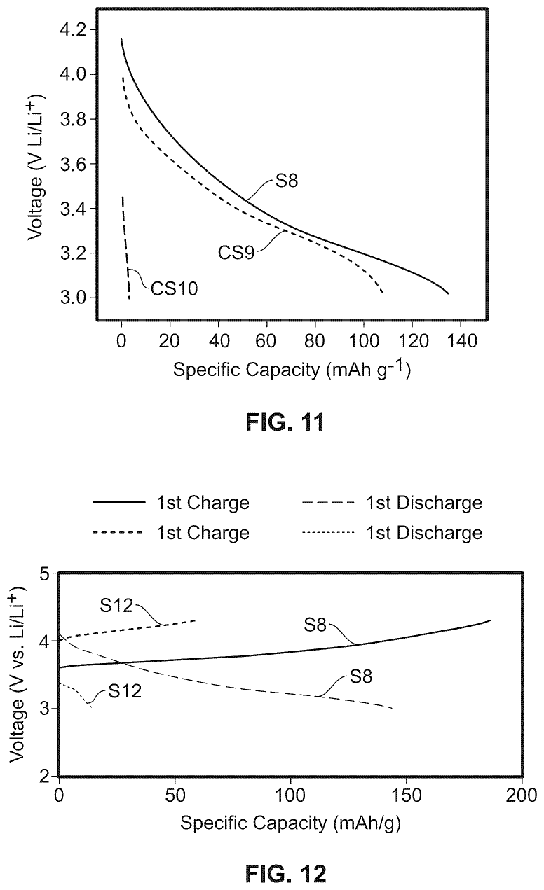

Cell S8 is formed having the cell configuration of Li/Sample S2/LYBC/cathode composite. Cell CS9 is formed having the same cell configuration except Sample S2 is replaced with Li₂OHBr. Cell CS10 is formed having the configuration of Li/LYBC/cathode composite. The cell samples have the same cathode composite including 60% (w/w) of NMC622 particles pretreated with fluorine using plasma-enhanced chemical vapor deposition, LYBC (40% w/w), and vapor grown carbon fiber of 0.5% w/w relative to the total weight of NMC622 and LYBC. Discharge capacities of the first charge/discharge cycle of the cells are illustrated in FIG. 11. It can be observed discharge capacities of Cell S8 are significantly higher than Cells CS9 and CS10. For example, Cell S8 demonstrated the discharge capacity of 140 mAh g⁻¹ comparing to 4 mAh g⁻¹ by Cell CS10 and 107 mAh g⁻¹ of CS9.

### Example 4

Solid electrolyte material sample S11 is formed as follows. Powders of LiF, LiCl, and LiOH are mixed and ground to form a soft mixture, which is then heat at 350° C. for 1 h to form Sample S11. The mole ratio of LiOH:LiF:LiCl is 0.9:0.1:1.

Cell S12 is formed having the same configuration as Cell S8, except Sample S2 is replaced with S11.

The galvanostatic cycling was performed using the same conditions described in Example 1. Test results of Cells S8 and S12 are illustrated in FIG. 12. Cell Sample S12 has an initial specific capacity of 60 mAh g⁻¹ at the first charge step, and the specific capacity drops to 13 mAh g⁻¹ for the subsequent discharge step. Cell Sample S8 has an initial specific capacity of approximate 180 mAh g⁻¹ at the first charge step, which drops to approximate 140 mAh g⁻¹ for the subsequent discharge step. Cell Sample S8 appears to have improved charge/discharge capacities and capacity retention compared to Cell Sample S12.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Reference herein to a material including one or more components may be interpreted to include at least one embodiment wherein the material consists essentially of the one or more components identified. The term “consisting essentially” will be interpreted to include a composition including those materials identified and excluding all other materials except in minority contents (e.g., impurity contents), which do not significantly alter the properties of the material. Additionally, or in the alternative, in certain non-limiting embodiments, any of the compositions identified herein may be essentially free of materials that are not expressly disclosed. The embodiments herein include range of contents for certain components within a material, and it will be appreciated that the contents of the components within a given material total 100%.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A solid electrolyte material, comprising:
a first solid electrolyte material overlying at least a portion of a second solid electrolyte material,
wherein the first solid electrolyte material comprises an oxyhalide material represented by MₐMe_{f}O_{b}X_{c}, wherein M comprises an alkali metal, X comprises a halogen, 0≤f≤1, a/b>3, c=a+(k×f)−2b, k is a valence of Me, and Me comprises a metal different from M; and
wherein the second solid electrolyte material comprises a halide material different from the first solid electrolyte material.

2. The solid electrolyte material of claim 1, wherein the first solid electrolyte material further comprises a hydroxyl halide material represented by M′ₘ(Me′)_{f′}(OH)ₙX′ₚ, wherein M′ comprises an alkali metal, X′ comprises a halogen, 1≤m≤5, 0≤f′≤1, 1≤n≤4, p=m+(k′×f)−n, k′ is a valence of Me′, and Me′ comprises a metal different from M′.

3. The solid electrolyte material of claim 2, wherein M′ and M includes a same alkali metal.

4. The solid electrolyte material of claim 3, wherein the alkali metal includes Li.

5. The solid electrolyte material of claim 2, wherein X′ and X includes at least one of Cl or Br.

6. The solid electrolyte material of claim 2, comprising a weight content ratio of the oxyhalide to the hydroxyl halide, C_{MOX}/C_{MOHX}, of at least 0.05, wherein C_{MOX} is a weight content of the oxyhalide for a total weight of the first solid electrolyte material; and C_{M′OHX′} is a weight content of the hydroxyl halide for the total weight of the first solid electrolyte material.

7. The solid electrolyte material of claim 1, wherein the oxyhalide material comprises Li₇O₂X₃.

8. The solid electrolyte material of claim 2, wherein the hydroxyl halide material comprises a Li₂OHX, Li₄(OH)₃X, or a combination thereof.

9. The solid electrolyte material of claim 1, wherein the first solid electrolyte material comprises a dopant including fluorine.

10. The solid electrolyte material of claim 1, wherein the halide material of the second electrolyte material comprises M″_{3-z}(Me″)_{f″}X″_{3-z+k″*f″}, wherein −3≤z<3, 0<f″≤1, M″ comprises an alkali metal element, k″ is a valence of Me″, Me″ comprises a metal different from M″; and X″ comprises a halogen.

11. The solid electrolyte material of claim 1, wherein the first solid electrolyte material is in direct contact with at least the portion of the second solid electrolyte material.

12. The solid electrolyte material of claim 1, comprising coated particles including a coating including the first solid electrolyte material overlying at least a portion of a core including the second solid electrolyte material.

13. The solid electrolyte material of claim 1, comprising a layered structure, wherein the first solid electrolyte material is in a form of a film, a tape, a block, or a sheet, and has a thickness, t1, of at least 1 nm and at most 100 nm; and wherein the second solid electrolyte material is in a form of a film, a tape, a block, or a sheet, and has a thickness, t2, of not greater than 10 microns to 1 mm.

14. The solid electrolyte material of claim 1, wherein the first solid electrolyte material comprises a first crystalline phase including the oxyhalide material and a second crystalline phase including M′ₘ(Me′)_{f′}(OH)ₙX′ₚ, wherein M′ comprises an alkali metal, X′ comprises a halogen, 1≤m≤5, 0≤f′≤1, 1≤n≤4, p=m+(k′×f)−n, k′ is a valence of Me′, and Me′ comprises a metal different from M′.

15. A structure, comprising the solid electrolyte material of claim 14 and an anode, wherein the first solid electrolyte material is between the anode and the second solid electrolyte material.

16. The structure of claim 15, wherein the first solid electrolyte material is in direct contact with the anode.

17. A solid electrolyte material, comprising a polycrystal comprising A_{q} and B_{(1-q)}, wherein:
A is present in a first crystalline phase represented by MₐMe_{f}O_{b}X_{c}, wherein
M comprises an alkali metal;
X comprises a halogen;
Me comprises a divalent metal element, a trivalent metal element, a tetravalent metal element, a pentavalent metal element, a hexavalent metal element, or any combination thereof;
$$\begin{matrix}0 \leq f \leq 1 ; \\ a / b > 3 ; \\ c = a + ( k \times f ) - 2 b ;\end{matrix}$$
and
k is a valence of Me;
B is present in a second crystalline phase represented by M′ₘ(Me′)_{f′}(OH)ₙX′ₚ, wherein:
M′ comprises an alkali metal;
X′ comprises a halogen;
Me′ comprises a divalent metal element, a trivalent metal element, a tetravalent metal element, a pentavalent metal element, a hexavalent metal element, or any combination thereof;
$$\begin{matrix}1 \leq m \leq 5 ; \\ 0 \leq f ’ \leq 1 ; \\ 1 \leq n \leq 4 ; \\ p = m + ( k ’ \times f ’ ) - n ;\end{matrix}$$
and
k′ is a valence of Me′; and
wherein the polycrystal comprises a dopant including fluorine.

18. The solid electrolyte material of claim 17, wherein M′ and M include a same alkali metal element.

19. The solid electrolyte material of claim 17, wherein X and X′ independently comprises at least one of Cl or Br.

20. The solid electrolyte material of claim 17, wherein q is at least 0.05 not greater than 0.95.
